(19) United States
(12) Patent Application Publication
(10) Pub. No.: US 2007/0024347 A1
(43) Pub. Date: Feb. 1, 2007

(54) Semiconductor integrated circuit

(75) Inventors: Toshinobu Nagasawa, Osaka (JP); Tetsushi Toyooka, Kyoto (JP); Keiichi Fujii, Shiga (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi (JP)

(21) Appl. No.: 11/488,503

(22) Filed: Jul. 18, 2006

(30) Foreign Application Priority Data
Jul. 29, 2005 (JP) JP2005-221209

(51) Int. Cl. G05F 1/10

(52) U.S. Cl. 327/536

(57) ABSTRACT

A semiconductor integrated circuit includes a charge pump circuit for stepping down or stepping up a voltage supplied from a single voltage supply VDD and outputting the voltage, by repeating an operation of charging a flying capacitor C1 and transferring charges stored in the flying capacitor to a storage capacitor C2. During the operation of the charge pump circuit, current supply for charging the flying capacitor is carried out by a current mirror operation. The semiconductor integrated circuit thus obtained by including the charge pump circuit is characterized in that rush current on startup of charge pumping is reduced and that output performance of a DC-CD converter is not impaired.

### BACKGROUND OF THE INVENTION

1. Field of the Invention

The present invention relates to a semiconductor integrated circuit including a charge pump-type DC-DC converter.

2. Description of Related Art

Recently, in order to make a battery-driven portable device capable of longtime operation by reducing power consumption thereof, the reduction of its power supply voltage has been pursued. On the other hand, there has also been a demand that a signal processing circuit in a semiconductor integrated circuit should output an amplitude at an equal or greater level as compared with the conventional level. In the case where it is impossible to output a sufficient signal amplitude due to the reduction of the power supply voltage, a known technique has been used in which a necessary DC voltage is generated in a device by the stepping-up or stepping-down of a voltage with the use of a DC-DC converter and the DC voltage thus generated is used for outputting a sufficient signal amplitude. As a DC-DC converter, a configuration using a charge pump circuit has been known (see JP2003-219634A, for instance), which has been used widely in portable devices.

The following describes a semiconductor integrated circuit including a conventional charge pump circuit, referring to an example thereof of the step-down type. FIG. 9A is a semiconductor integrated circuit 11 including a conventional charge pump circuit. It should be noted that illustration of elements other than those in relation with the charge pump circuit is omitted in the drawing. The semiconductor integrated circuit 11 includes a charge pump circuit output stage 1, and gate drivers 2, 3, 4, and 6. C1 indicates a flying capacitor, and C2 indicates a storage capacitor.

The charge pump circuit output stage 1 is composed of a PMOS transistor M1, a NMOS transistor M2, a NMOS transistor M3, and NMOS transistor M4. A drain and a source of the transistor M1 are connected with a positive terminal of the flying capacitor C1 and a power supply VDD, respectively. A drain and a source of the transistor M2 are connected with a negative terminal of the flying capacitor C1 and a ground GND, respectively. A drain and a source of the transistor M3 are connected with a positive terminal of the flying capacitor C1 and the ground GND, respectively. A drain and a source of the transistor M4 are connected with a negative terminal of the flying capacitor C1 and the storage capacitor C2, respectively.

The gate drivers 6, 2, 3, and 4 are connected to gates of the transistors M1, M2, M3, and M4, respectively.

FIG. 9B shows an equivalent circuit diagram of the circuit shown in FIG. 9A. In FIG. 9B, R1 indicates an ON resistance of the transistor M1, R2 indicates an ON resistance of the transistor M2, R3 indicates an ON resistance of the transistor M3, and R4 indicates an ON resistance of the transistor M4.

FIGS. 10A and 10B illustrate an example of a configuration of a gate driver. In FIG. 10A, 30 indicates the gate driver symbolically illustrated. FIG. 10B illustrates an example of a configuration in which the gate driver 30 is an inverter circuit composed of a PMOS transistor M10 and a NMOS transistor M11.

FIG. 11 is a waveform diagram for explaining an operation of the circuit shown in FIGS. 9A and 9B, in which the horizontal axis t indicates time. In FIG. 11(a), φ1 indicates a gate voltage of the transistor M1, φ2 indicates a gate voltage of the transistor M2, and φ3 indicates a gate voltage of the transistors M3 and M4. FIG. 11(b) shows a transient characteristic of a drain current I of the PMOS transistor M1, which flows from the power supply VDD. FIG. 11(c) shows a transient characteristic of a voltage VC that appears between both terminals of the flying capacitor C1. FIG. 11(d) shows a transient characteristic of a charge voltage VSS of the storage capacitor C2. The current values and voltage values in the drawings are values when VDD=3V, C1=C2=1 μF, and R1=R2=R3=R4=0.5 Ω.

FIGS. 12, (a) and (b), illustrates transient characteristics of the drain current I of the transistor M1 and the charge voltage VSS in a longer range along the time axis.

The following describes an operation of the conventional charge pump circuit, while referring to the circuit configuration shown in FIGS. 9A and 9B and the operation diagram shown in FIG. 11. When with the gate voltage φ3 being at low level (“L” level), the gate voltage φ1 and the gate voltage φ2 simultaneously are shifted from high level (“H” level) to “L” level and from “L” level to “H” level, respectively, the transistors M3 and M4 are turned off while the transistors M1 and M2 are turned on. In the equivalent circuit shown in FIG. 9B, this is a state in which switches SW10 and SW11 are switched to the left side, whereby the charge current I flows from the power supply VDD to the flying capacitor C1, to start the charging. The transient current I flowing from the power supply VDD to the flying capacitor C1, a potential difference VC between the both terminals of the flying capacitor C1, and the charge voltage VSS exhibit transient characteristics in a period A shown in FIGS. 11, (b), (c), and (d). In the case of the above-described conditions, the transient current I flowing from the power supply VDD to the flying capacitor C1 has a peak of 3 A.

Then, when the gate voltages φ1 and φ2 are shifted to “H” level and “L” level, respectively, and subsequently the gate voltage φ3 is shifted from “L” level to “H” level, the transistors M1 and M2 are turned off while the transistors M3 and M4 are turned on. In the equivalent circuit shown in FIG. 9B, the switches SW10 and SW11 are switched to the right side, whereby charges stored in the flying capacitor C1 are transferred to the storage capacitor C2 in accordance with the charge conservation principle. The transient current flowing from the power supply VDD to the flying capacitor C1, the potential difference VC between the both terminals of the flying capacitor C1, and the charge voltage VSS exhibit transient characteristics in a period B shown in FIGS. 11, (b), (c), and (d). Likewise, the gate voltages φ1, φ2, and φ3 continue to alter as shown in FIG. 11(a), so that the charging is continued until the charge voltage VSS finally has a value of −VDD as shown in FIG. 12(b).

Further, by using a gate driver as shown in FIG. 10B capable of causing the gate voltage to make a significant transition from VDD to VSS, it is possible to decrease the ON resistance during the ON operations of the transistors M1, M2, M3, and M4 of the charge pump circuit output stage 1, thereby enhancing the output performance of the charge pump circuit.

However, in the case of the above-described conventional configuration, the transient current when the operation of the charge pump circuit starts has a high peak (hereinafter referred to as rush current), and this possibly causes the power supply to go down in the case where the power supply voltage VDD has low performance. In a portable device, particularly, the performance of the power supply is generally low, and in many cases a power supply system is shared by the circuit and the other circuit blocks together. Therefore, there is a possibility that the influence of the rush current is extended not only to the semiconductor integrated circuit including the charge pump circuit but also to the other semiconductor integrated circuits connected to the same power supply. Thus, decreasing the rush current is a task of great significance.

As a means for solving the above-described problem, JP2003-219634A discloses a configuration including a preliminary charging circuit for preliminarily charging a flying capacitor and a storage capacitor when a charging pump circuit is in a non-operation state. However, the configuration of JP2003-219634A is not capable of sufficiently decreasing the rush current, and hence, it is insufficient as a means for avoiding the influence of the rush current on the other circuit elements.

### SUMMARY OF THE INVENTION

It is an object of the present invention to provide a semiconductor integrated circuit including a charge pump circuit capable of sufficiently reducing rush current at the beginning of charge pumping.

The semiconductor integrated circuit of the present invention includes a charge pump circuit for stepping down or stepping up a voltage supplied from a single voltage supply and outputting the voltage, by repeating an operation of charging a flying capacitor and transferring charges stored in the flying capacitor to a storage capacitor, wherein during the operation of charge pump circuit, current supply for charging the flying capacitor is carried out by a current mirror operation.

### BRIEF DESCRIPTION OF THE DRAWINGS

FIG. 1A is a circuit diagram of a semiconductor integrated circuit according to Embodiment 1 of the present invention.

FIG. 1B is an equivalent circuit diagram of the same semiconductor integrated circuit.

FIG. 2 is a waveform diagram for explaining an operation of the same semiconductor integrated circuit.

FIG. 3 is a waveform diagram showing an operation of the same semiconductor integrated circuit in a longer time range.

FIG. 4 is a circuit diagram of a semiconductor integrated circuit according to Embodiment 2 of the present invention.

FIG. 5A is a waveform diagram for explaining transient operation of the same semiconductor integrated circuit.

FIG. 5B is a waveform diagram for explaining transient operation in another state of the same semiconductor integrated circuit.

FIG. 6 is a circuit diagram of a semiconductor integrated circuit according to Embodiment 3 of the present invention.

FIG. 7 is a timing chart showing a control operation performed by the same semiconductor integrated circuit.

FIG. 8 is a block diagram of a semiconductor integrated circuit according to Embodiment 4 of the present invention.

FIG. 9A is a circuit diagram of a semiconductor integrated circuit of a conventional example.

FIG. 9B is an equivalent circuit diagram of the same semiconductor integrated circuit.

FIGS. 10A and 10B illustrate an example of a gate driver of the same semiconductor integrated circuit.

FIG. 11 is a waveform diagram for explaining an operation of the same semiconductor integrated circuit.

FIG. 12 is a waveform diagram showing an operation of the same semiconductor integrated circuit in a longer time range.

### DETAILED DESCRIPTION OF THE INVENTION

The semiconductor integrated circuit of the present invention includes a charge pump circuit for stepping down or stepping up a voltage supplied from a single voltage supply. The step down or step up is performed by repeating an operation of charging a flying capacitor and transferring charges stored in the flying capacitor to a storage capacitor. During the operation of charge pump circuit, current supply for charging the flying capacitor is carried out by a current mirror operation.

The semiconductor integrated circuit of this configuration makes it possible to reduce sufficiently the rush current generated on startup of the charge pump circuit by limiting the charge current by the current mirror operation.

The semiconductor integrated circuit of the present invention may be configured to include further: first and second transistors for connecting the flying capacitor between the voltage supply and a ground potential so as to charge the flying capacitor; third and fourth transistors for connecting one terminal of the flying capacitor to a ground potential, and connecting in series the other terminal of the flying capacitor with the storage capacitor whose one terminal is connected to a ground potential so as to cause charges stored in the flying capacitor to be transferred to the storage capacitor; and a gate driver including a fifth transistor and a constant current source, the fifth transistor constituting a current mirror together with either the first transistor or the second transistor.

The gate driver preferably increases a current amount of the first or second transistor for the current mirror operation after the charging is started and the charging of the storage capacitor is finished.

In this case, the semiconductor integrated circuit may be configured to include further a first constant current source, and a second constant current source supplying a current in a greater amount as compared with the first constant current source, as the constant current source of the gate driver, so that during the operation of the charge pump circuit, the current mirror operation of the first or second transistor is carried out with the first constant current source, and after the charging is started and the charging of the storage capacitor is finished, the current mirror operation of the first or second transistor is carried out with the second constant current power source.

The semiconductor integrated circuit may be configured so that after a predetermined amount of charges is transferred from the flying capacitor to the storage capacitor, the current mirror operation by the fifth transistor and the constant current source is stopped.

The semiconductor integrated circuit may be configured so that the gate driver is capable of selectively performing the current mirror operation or an operation for supplying a gate driving voltage via an inverter, and after the predetermined amount of charges from the flying capacitor is stored in the storage capacitor, the gate driver switches the current mirror operation to the operation via the inverter.

A semiconductor integrated circuit device can be configured to include a semiconductor integrated circuit with any one of the above-described configurations, and a signal processing circuit employing an output of the charge pump circuit of the semiconductor integrated circuit as a power supply, the semiconductor integrated circuit and the signal processing circuit being mounted integrally on one substrate.

The following describes semiconductor integrated circuits including charge pump circuits according to Embodiments of the present invention while referring to the drawings.

Embodiment 1

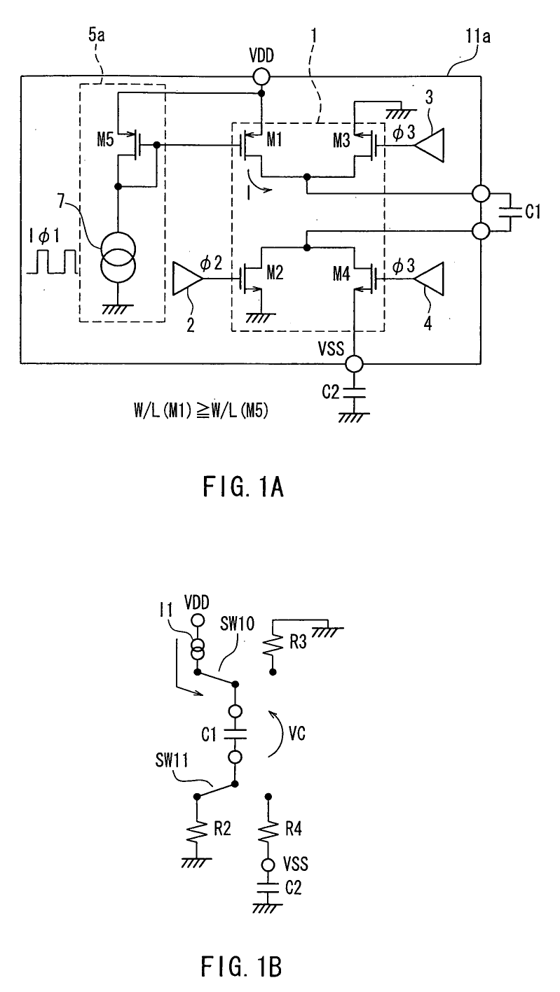

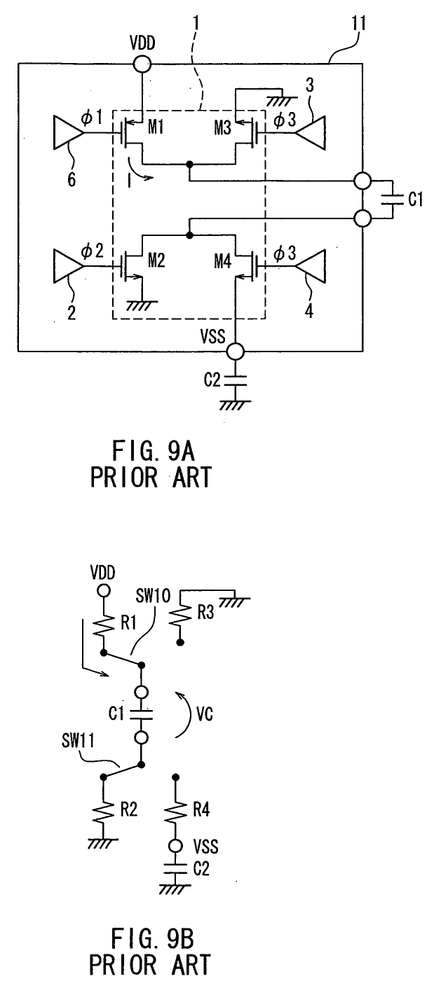

FIG. 1A illustrates a semiconductor integrated circuit 11a including a charge pump circuit according to Embodiment 1 of the present invention. It should be noted that illustration of elements other than those in relation to the charge pump circuit is omitted in the drawing. In FIG. 1A, the same elements as those of the conventional example shown in FIG. 9A are designated by the same reference numerals and repetitive descriptions of the same are avoided.

The semiconductor integrated circuit 11a includes a charge pump circuit output stage 1 and gate drivers 2, 3, 4, and 5a. In the present embodiment, the configuration of the gate driver 5a for a PMOS transistor M1 is different from the circuit shown in FIG. 9A. The gate driver 5a is composed of a PMOS transistor M5 and a clock current source 7, and with diode connection of a PMOS transistor M5, a primary side of a current mirror is constituted.

FIG. 1B is an equivalent circuit diagram of the circuit shown in FIG. 1A. In FIG. 1B, a current source I1 indicates an equivalent circuit in a current mirror operation, R2 indicates an ON resistance of the transistor M2, R3 indicates an ON resistance of the transistor M3, and R4 indicates an ON resistance of the transistor M4.

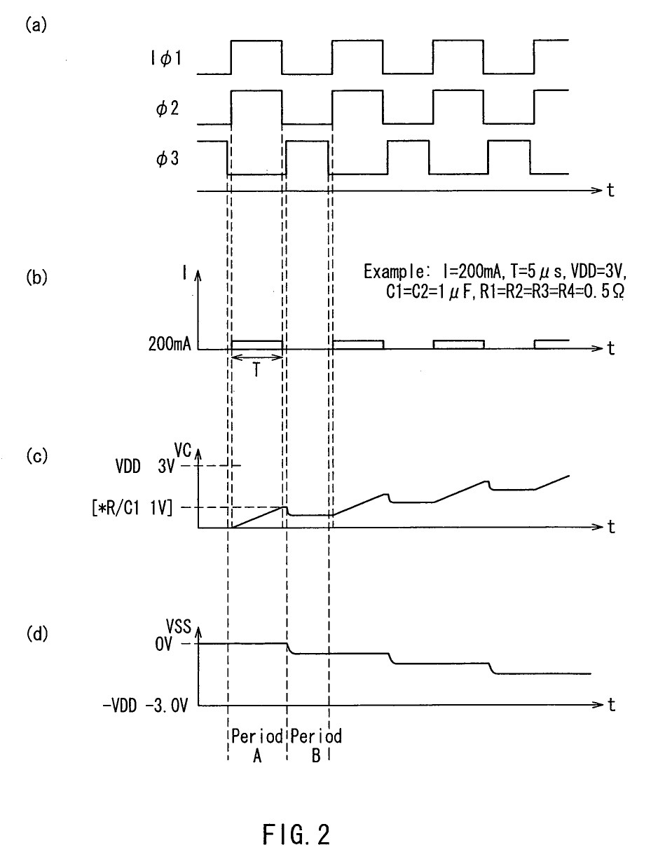

FIG. 2 illustrates the operation of the circuit shown in FIG. 1A, in which the horizontal axis t indicates time. In FIG. 2(a), Iφ1 indicates a current flowing through the transistor M5, φ2 indicates a gate voltage of the transistor M2, and φ3 indicates a gate voltage of the transistors M3 and M4. FIG. 2(b) shows a transient characteristic of a drain current I of the transistor M1, which flows from the power supply VDD. FIG. 2(c) shows a transient characteristic of a voltage VC at both terminals of the flying capacitor C1. FIG. 2(d) shows a transient characteristic of a charge voltage VSS of the storage capacitor C2. The current values and voltage values in the drawings are values when the drain current I of the transistor M1=200 mA, VDD=3V, C1=C2=1 μF, and R1=R2=R3=R4=0.5 Ω.

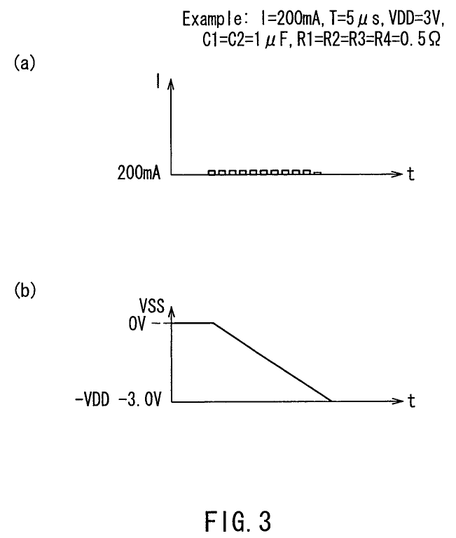

FIG. 3(a) illustrates a transient characteristic of the drain current I of the transistor M1 over a longer range along the time axis, and FIG. 3(b) illustrates a transient characteristic of the charge voltage VSS over a longer range along the time axis.

The following describes an operation of a semiconductor integrated circuit including of the charge pump circuit configured as described above, while referring to the circuit configuration shown in FIGS. 1A and 1B and the operation diagram shown in FIG. 2. When the gate voltage φ3 is at low level (“L” level), the current Iφ1 is shifted from a current 0 state to a current ON state and the gate voltage φ2 is shifted from “L” level to high level (“H” level), which causes the transistors M3 and M4 to be turned off and causes the transistor M2 to be turned on. This is a state shown in the equivalent circuit of FIG. 1B in which switches SW10 and SW11 are switched to the left side. Since the transistor M1 performs a current mirror operation, the charge current I in an amount determined according to a mirror ratio of the transistor M5 is caused to flow to the flying capacitor C1. The transient current I flowing from the VDD to the flying capacitor C1, a potential difference VC between the both ends of the flying capacitor C1, and the charge voltage VSS exhibit transient characteristics in the period A shown in FIGS. 2, (b), (c), and (d), respectively. In the case of the above-described example, the transient current I flowing from the VDD to the flying capacitor C1 has a peak of 200 mA.

Next, the current Iφ1 is shifted from a current ON state to a current 0 state, and the gate voltage φ2 is shifted from “H” level to “L” level, which is followed subsequently by a shift of the gate voltage φ3 from “L” level to “H”level. This causes the transistors M1 and M2 to be turned off and causes the transistors M3 and M4 to be turned on. This is a state in which switches SW10 and SW11 are switched to the right side in the equivalent circuit of FIG. 1B. Charges stored in the flying capacitor C1 are transferred to the storage capacitor C2 in accordance with the charge conservation principle. The transient current flowing from the VDD to the flying capacitor C1, the potential difference between the both terminals of the flying capacitor C1, and the charge voltage VSS exhibit transient characteristics in the period B shown in FIGS. 2, (b), (c), and (d), respectively.

Likewise, Iφ1, φ2, and φ3 continuously make transitions as shown in FIG. 2(a) so that the charging is carried out until finally the charge voltage VSS has a value of −VDD as shown in FIG. 3(b). Thus, according to the present embodiment, with the above-described constants, the transient current on startup of the charge pump circuit has a peak of 200 mA, lower than the peak of 3 A in the conventional circuit, which means that it is possible to reduce the peak current on startup. Further, it also is possible to change the setting of the peak current amount on startup, based on a mirror ratio of the transistor M5 and the transistor M1.

Embodiment 2

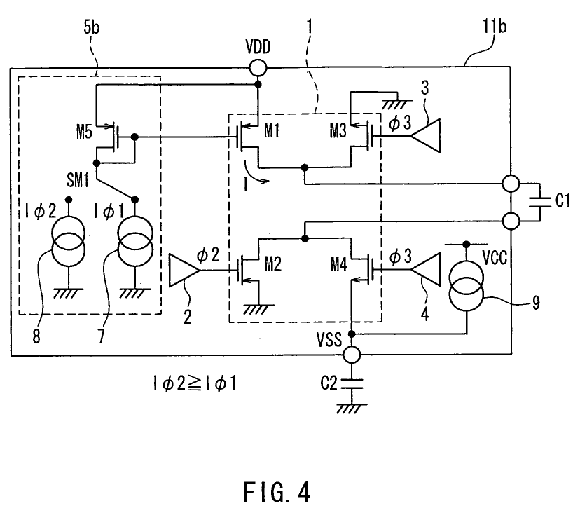

FIG. 4 illustrates a semiconductor integrated circuit 11b including a charge pump circuit according to Embodiment 2 of the present invention. In FIG. 4, the same elements as those of the circuit shown in FIG. 1A are designated by the same reference numerals and repetitive descriptions of the same are avoided.

The semiconductor integrated circuit 11b includes a charge pump circuit output stage 1 and gate drivers 2, 3, 4, and 5b. In the present embodiment, the configuration of the gate driver 5b of a PMOS transistor M1 is a difference from the circuit shown in FIG. 1A. The gate driver 5b is composed of a PMOS transistor M5, a clock current source 7 for preliminary charging, a clock current source 8 for main charging, and a switch SW1. With diode connection of a PMOS transistor M5, the gate driver constitutes a primary side of a current mirror. The clock current source 7 supplies a pulse current Iφ1, the clock current source 8 supplies a pulse current Iφ2 (current amount: Iφ2≧Iφ1), and either one of the current sources is connected to the transistor M5 selectively by the switch SW1. 9 indicates a current IL consumed from VSS.

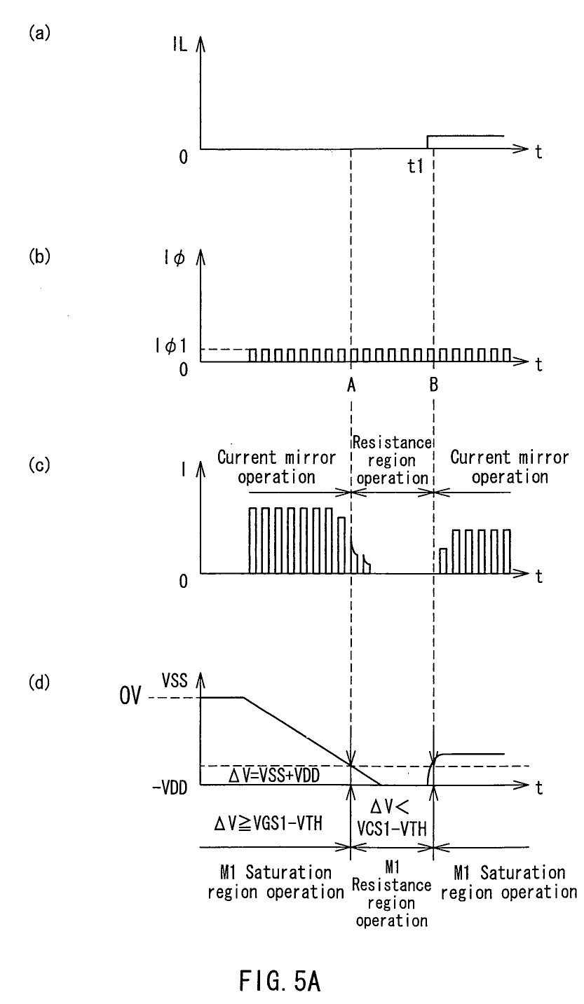

FIGS. 5A and 5B show transient characteristics of the charge pump circuit according to the present embodiment. FIG. 5A shows a transient characteristic thereof in the case where the circuit shown in FIG. 4 is operated with supply of only the pulse current Iφ1 from the clock current source 7 for preliminary charging. FIG. 5B shows a transient characteristic of the circuit in the case where the circuit starts operation in a state where the switch SW1 is turned to the position for connection to the clock current source 7, and after the storage capacitor C2 is charged sufficiently, the switch SW1 is turned to the position for connection to the clock current source 8 for main charging so that the pulse current Iφ2 is supplied.

FIG. 5A(a) and FIG. 5B(a) show transient characteristics of a current IL flowing to the VSS. FIG. 5A(b) and FIG. 5B(b) show transient characteristics of a drain current Iφ of the PMOS transistor M5 on a primary side of a current mirror. FIG. 5A(c) and FIG. 5B(c) show transient characteristics of a drain current I of the PMOS transistor M1. FIG. 5A(d) and FIG. 5B(d) show transient characteristics of a charge voltage VSS.

The following describes an operation in the case where only the pulse current Iφ1 from the clock current source 7 is supplied to the circuit in FIG. 4, that is, an operation in a state corresponding to Embodiment 1, while referring to FIG. 5A, (a) to (d). The pulse current Iφ1 is set to have a small amplitude as shown in FIG. 5A(b) so as to reduce the rush current. With supply of the pulse current Iφ1 shown in FIG. 5A(b), the transistor M1 initially performs a current mirror operation, like the charge pump circuit according to Embodiment 1. This causes the drain current I of the transistor M1 to flow as shown in FIG. 5A(c), and the charging of the flying capacitor C1 and the transfer of charges to the storage capacitor C2 are repeated, whereby the charging is promoted so that the charge voltage VSS has a negative voltage value.

As shown in FIG. 5A(d), during the period since the charging is started until the charge voltage VSS has a value of VDD−ΔV (until time A), the transistor M1 operates in a saturation region. ΔV=VGS1−VTH is satisfied where VGS1 is a gate-source voltage of the transistor M1, and VTH is a threshold value of the transistor M1. As shown in FIG. 5A(c), during the period from the start of the operation of the charge pump circuit to the time A, the transistor M1 continues the current mirror operation.

As the charge voltage VSS comes to have a value lower than VDD−ΔV through charging, the transistor M1 operates in a resistance region, and the charge current amount determined by the transistor M1 decreases as shown in the A-B period in FIG. 5A(c). When the charge voltage VSS comes to have a value of −VDD through charging, the current I ideally becomes 0. However, if the consumption current IL flows to the VSS at the time t1 and thereafter as shown in FIG. 5A(a), with the drain current Iφ being maintained in a rush current reduced state (Iφ1), the transistor M1 has a high ON resistance since it operates in the resistance region in a state in which the potential difference of the gate-source voltage VGS1 is not significantly great. Therefore, there is a possibility that the consumption current IL flowing to the VSS cannot be compensated sufficiently.

In such a case, the value of the charge voltage VSS increases as shown in FIG. 5A(d), thereby causing the transistor M1 to operate again in the saturation region at the time B and thereafter, and the charge voltage VSS increases to a value such that the consumption current IL can be compensated. In the worst case, a negative voltage is not generated in the VSS. For instance, in the case of a system where the power conversion efficiency is 100% and a charge-discharge duty ratio with respect to the flying capacitor is 50%, if an average value of the current IL consumed at the VSS is not less than half of the peak value of the drain current I of the transistor M1 during the current mirror operation, the charge pump circuit cannot generate a negative voltage. Since high performance of the charge pump circuit is proved by the capability of maintaining a sufficiently low value of the charge voltage VSS even with a current flowing to the VSS, such an increase of the charge voltage VSS after the time B that causes the transistor M1 to operate in the saturation region, as in the state shown in FIG. 5A(d), means that the performance of the charge pump circuit output is poor.

To improve the insufficient output performance of the charge pump circuit, the charge pump circuit according to the present embodiment is configured as shown in FIG. 4 such that, after the charging by the clock current source 7 for obtaining a sufficient charge voltage VSS, the current source to be used is switched to the clock current source 8 by the switch SW1 so that the current to be supplied is switched from the pulse current Iφ1 to a pulse current Iφ2 with a greater current amount. This operation is described with reference to FIG. 5B, (a) to (d). In the drawing, the operation before the time D is identical to the above-described operation of FIG. 5A, (a) to (d). As shown in FIG. 5B(b), at the time D, the state shown in FIG. 4 in which the switch SW1 is switched to the clock current source 7 side is changed to the state in which the switch SW1 is switched to the clock current source 8 side that supplies current in a greater amount. Thereby, the ON resistance of the transistor M1 in the resistance region is decreased, so as to increase the charge current amount in the resistance region operation, as shown in FIG. 5B(c). The pulse current Iφ2 may be set selectively so that the transistor M1 has an ON resistance sufficiently low with respect to an assumed consumption current IL; thereby, even if the current IL is consumed at the time t1, an increase in the charge voltage VSS can be reduced as shown in FIG. 5B(d), since the charge current amount is increased as compared with the case of the pulse current Iφ1 shown in FIG. 5A(d). Therefore, it is possible to reduce the rush current as is the case with Embodiment 1, as well as to avoid impairment of the charge pumping performance after charging.

Embodiment 3

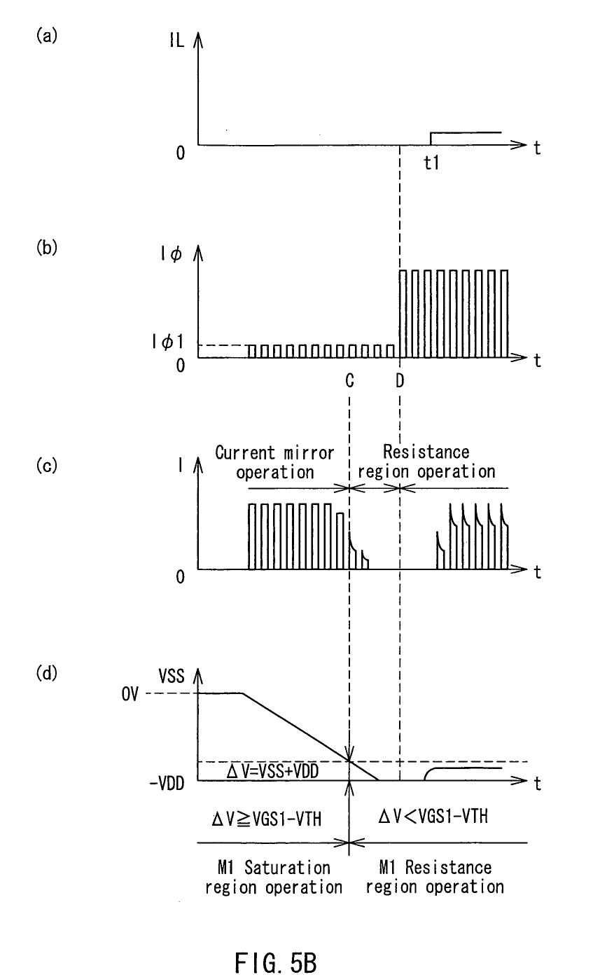

FIG. 6 illustrates a semiconductor integrated circuit 11c including a charge pump circuit according to Embodiment 3 of the present invention. In FIG. 6, the same elements as those of the circuits shown in FIGS. 1A and 9A are designated by the same reference numerals, and repetitive descriptions thereof are avoided.

The semiconductor integrated circuit 11c includes a charge pump circuit output stage 1, gate drivers 2, 3, 4, 5c, and 6, and a switch SW5. In the present embodiment, a gate of a PMOS transistor M1 is connected selectively with the gate driver 6 additionally, other than the gate driver 5c, via the switch SW5.

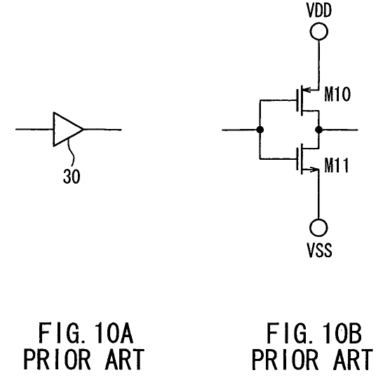

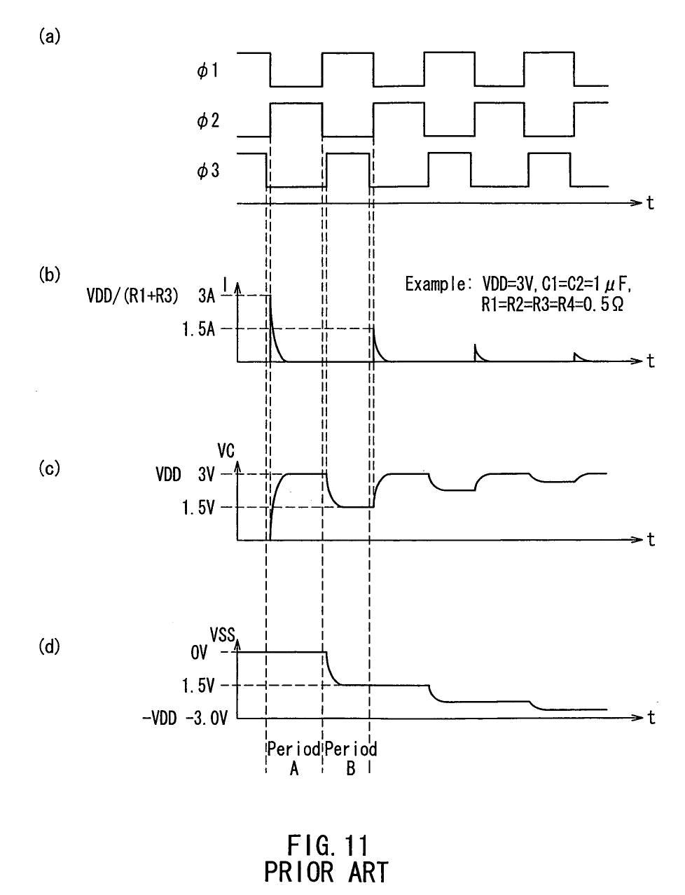

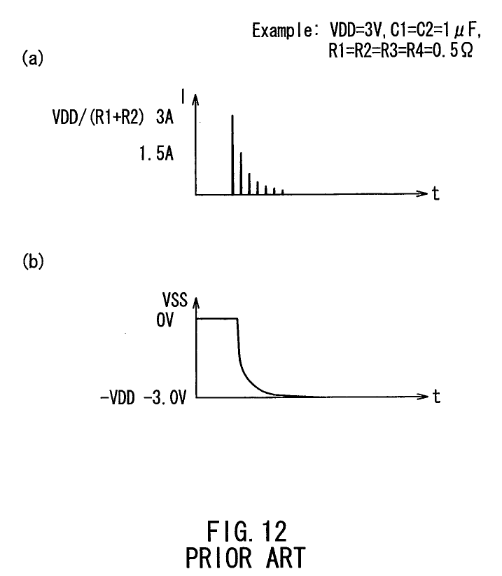

The gate driver 5c is composed of a PMOS transistor M5, NMOS transistors M6 and M7, a current source IDC10, a current pulse generation switch SW2, a switch SW3, and a switch SW4. The current pulse generation switch SW2 is provided for forming a current clock. The switch SW3 is provided for preventing the gate from becoming unstable. The switch SW4 is provided for controlling ON/OFF of a current mirror operation. It should be noted that the gate driver 6, which is turned on/off by the switch SW5, operates in the same manner as the gate driver 6 of the conventional example shown in FIGS. 9A to 12.

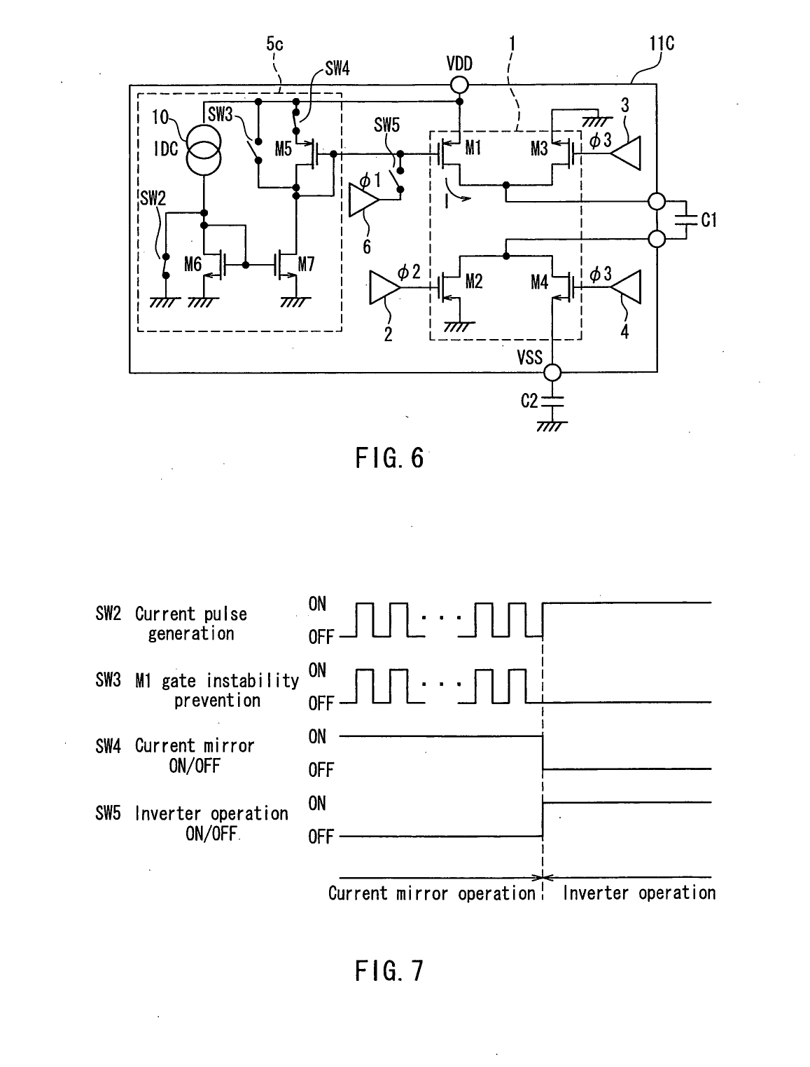

FIG. 7 is a timing chart for explaining the control operation by the switches SW2 to SW5 composing the charge pump circuit according to Embodiment 3. On startup of charge pumping, the switch SW4 for the ON/OFF control of current mirror is turned on, the switch SW5 for the ON/OFF control of an inverting operation by the gate driver 6 is turned off, and the current pulse generation switch SW2 and the gate instability preventing switch SW3 are turned on and turned off repetitively in phase with each other. During this operation, the circuit operates in the same manner as in Embodiment 1.

Next, after a sufficient charge is stored, the switch SW4 is turned off, the switch SW5 is turned on, the current pulse generation switch SW2 is turned on, the switch SW3 is turned off, and this state is fixed. With the controlling operation as shown in FIG. 7, in the present embodiment, it is possible to, as is the case with Embodiment 2, reduce the rush current even with consumption current at the node VSS as in the operation shown in FIG. 5A, (a) to (d), as well as to avoid impairment of the charge pumping performance after charging.

Embodiment 4

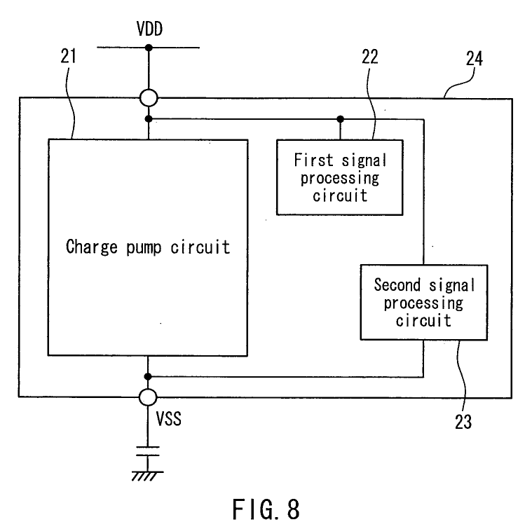

FIG. 8 illustrates a semiconductor integrated circuit including a charge pump circuit according to Embodiment 4 of the present invention. FIG. 8 shows a configuration of a semiconductor integrated circuit 24 in which a charge pump circuit and signal processing circuits employing an output of the charge pump circuit as a power supply are mounted integrally on one substrate.

The semiconductor integrated circuit 24 shown in FIG. 8 is composed of a charge pump circuit 21, a first signal processing circuit 22, and a second signal processing circuit 23. The charge pump circuit 21 has a configuration according to any one of Embodiments 1 to 3. The first signal processing circuit 22 operates between the same power supply voltage VDD as that for the charge pump circuit 21 and a ground GND, independently from startup and stopping of the charge pump circuit 21. The second signal processing circuit 23 uses an output of the charge pump circuit 21 as a voltage supply source.

In the configuration of FIG. 8, if a charge pump circuit of the conventional example is used in place of the charge pump circuit 21, the first signal processing circuit 22 possibly causes a system failure due to the rush current at startup of the charge pump circuit that causes the power supply voltage VDD to go down. In contrast, in the present embodiment in which the charge pump circuit 21 having a configuration according to any one of Embodiments 1 to 3 of the present invention, it is possible to reduce the rush current at startup of the charge pump circuit 21, thereby preventing the power supply voltage VDD from going down and avoiding a system failure.

Further, with the configuration in which the charge pump circuit 21, the first signal processing circuit 22 operating independently from startup and stopping of the charge pump circuit 21, and the second signal processing circuit 23 employing an output of the charge pump circuit 21 as a voltage supply source are mounted integrally on one substrate, it is possible to incorporate signal processing circuits having a signal processing function that requires a large signal amplitude with a low power supply voltage, or being capable of sensitive power management. Thus, it is possible to achieve a multifunctional semiconductor integrated circuit.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A semiconductor integrated circuit comprising a charge pump circuit for stepping down or stepping up a voltage supplied from a single voltage supply and outputting the voltage, by repeating operations of charging a flying capacitor and transferring charges stored in the flying capacitor to a storage capacitor,
wherein during the operation of the charge pump circuit, current supply for charging the flying capacitor is carried out by a current mirror operation.

2. The semiconductor integrated circuit according to claim 1, further comprising:
first and second transistors for connecting the flying capacitor between the voltage supply and a ground potential so as to charge the flying capacitor;
third and fourth transistors for connecting one terminal of the flying capacitor to a ground potential, and connecting in series the other terminal of the flying capacitor with the storage capacitor whose one terminal is connected to a ground potential so as to cause charges stored in the flying capacitor to be transferred to the storage capacitor; and
a gate driver including a fifth transistor and a constant current source, the fifth transistor constituting a current mirror together with either the first transistor or the second transistor.

3. The semiconductor integrated circuit according to claim 2, wherein the gate driver increases a current amount of the first or second transistor for the current mirror operation after the charging is started and the charging of the storage capacitor is finished.

4. The semiconductor integrated circuit according to claim 3,
wherein the constant current source of the gate driver comprises:
a first constant current source; and
a second constant current source supplying a current in a greater amount as compared with the first constant current source, and
wherein during the operation of the charge pump circuit, the current mirror operation of the first or second transistor is carried out with the first constant current source, and
after the charging is started and the charging of the storage capacitor is finished, the current mirror operation of the first or second transistor is carried out with the second constant current power source.

5. The semiconductor integrated circuit according to claim 2, wherein after a predetermined amount of charges are transferred from the flying capacitor to the storage capacitor, the current mirror operation by the fifth transistor and the constant current source is stopped.

6. The semiconductor integrated circuit according to claim 5, wherein
the gate driver is capable of selectively performing the current mirror operation or an operation for supplying a gate driving voltage via an inverter, and
after the predetermined amount of charges from the flying capacitor is stored in the storage capacitor, the gate driver switches the current mirror operation to the operation via the inverter.
